(19) United States
(12) Patent Application Publication
(10) Pub. No.: US 2007/0195128 A1
(43) Pub. Date: Aug. 23, 2007

(54) Steady flow, high voltage inkjet print head for an ink cartridge

(76) Inventor: Alex Kuo-Shen Wang, Las Vegas, NV (US)

Correspondence Address: PRO-TECHTOR INTERNATIONAL SERVICES, 20775 NORADA CT., SARATOGA, CA, 95070, US

(21) Appl. No.: 11/361,096

(22) Filed: Feb. 23, 2006

(51) Int. Cl. B41J 2/05

(52) U.S. Cl. 347/56

(57) ABSTRACT

A steady flow, high voltage inkjet print head for an ink cartridge, wherein an inkjet print head chip includes a plurality of heating elements, and a top edge of the heating element (that is, resistance heating element) is structural designed as an arc-shaped resistance heating element. Because geometric center (that is, heat source center) of the material of the inkjet print head chip and a bubble forming center are in a straight line, thus, deviation between the bubble center point and expected emission direction is prevented, which would otherwise result in problems in Ink spot quality, thereby providing enormous benefit to high resolution of an Inkjet printer.

### BACKGROUND OF THE INVENTION

(a) Field of the Invention

The present invention relates to a structural design for an arc-shaped top edge of heating elements for an inkjet print head chip, wherein geometric center (that is, heat source center) of the material of a chip and a bubble forming center are in a straight line, thereby only enabling the bubbles to be formed from the heat source center, which prevents deviation between the bubble center point and expected emission direction that would otherwise result in problems in Ink spot quality.

(b) Description of the Prior Art

Laser printers and inkjet printers are the primary printers in the general market, and the printing technologies used in these two types of printers have their advantages and disadvantages. Presently, inkjet printing technology is the major printing technology used for color printing, and includes use of a thermal bubble inkjet print head that employs heating elements (such as: resistance heater elements) to momentarily direct high heat towards ink to produce bubbles, which are then sprayed out.

Referring to FIG. 1, which shows a cross-sectional view of a traditional inkjet printer heating element, wherein, because structure of the inkjet print head chip includes a plurality of heating elements 100, a top edge 1001 of which assumes an inverted ladder-shape, and edges are rectilinear, thus, when a heat source center is forming bubbles, a deviation phenomenon occurs at the bubble forming center, which brings about undesirable results, including a fragmented inkjet (that is, a satellite inkjet), a delayed inkjet, a multispot inkjet, and so on. Because of the lack of control of the bubble forming center, thus, in order to provide more stable ink quality, accelerated resistance heating method resulting singly from high voltage used on the rectilinear top edge heating elements 100, not only results in enormous energy loss, but is also unable to fix position of the bubble center, thereby causing a wide variety of undesirable problems in inkjet quality.

### SUMMARY OF THE INVENTION

A primary objective of the present invention is to provide a structural design for an arc-shaped top edge of a plurality of heating elements (that is, resistance heater elements) of an Inkjet print head chip, wherein, because of the design of steady flow, high voltage arc-shaped resistance heater elements, and because geometric center (that is, heat source center) of the material of a print head chip and a bubble forming center are in a straight line, thus deviation between the bubble center point and expected emission direction is prevented, which would otherwise result in problems in Ink spot quality.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a cross-sectional view of a prior art inkjet printer heating element.

FIG. 2 shows a structural schematic view of an inkjet print head chip and ink cartridge according to the present invention.

FIG. 3 shows a cutaway view of the ink cartridge along the tangent 3-3 of FIG. 2 according to the present invention.

FIG. 4 shows a cross-sectional view of an inkjet printer heating element according to the present invention.

FIG. 5 shows a schematic view of the inkjet printer heating element forming bubbles according to the present invention.

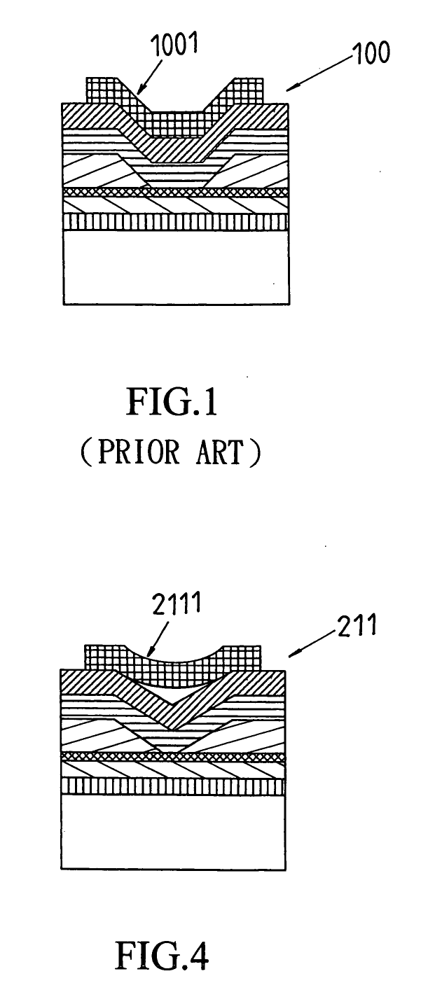

### DETAILED DESCRIPTION OF THE PREFERRED EMBODIMENTS

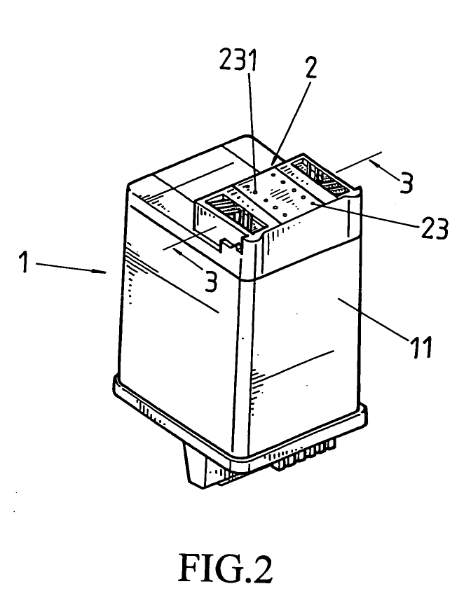

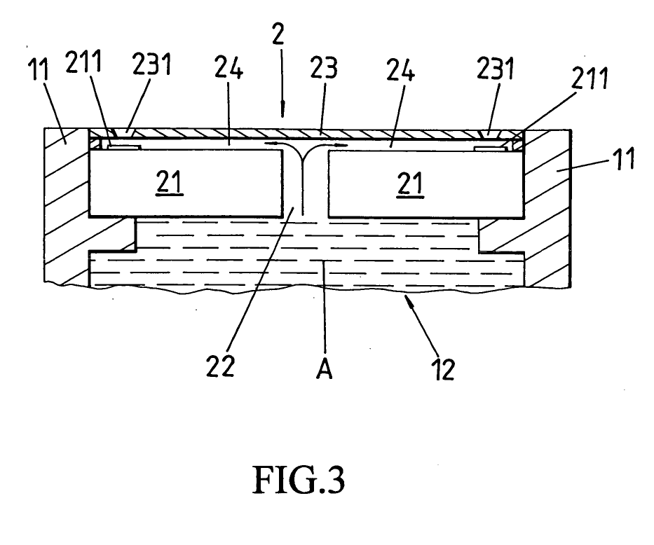

Referring to FIGS. 2 and 3, which show a schematic view of an ink cartridge 1 of the present invention and a cutaway view of the ink cartridge 1 along the tangent 3-3 of FIG. 2 respectively, wherein the ink cartridge 1 comprises a case 11, interior of which forms an ink storage tank 12 that is used to store ink A and an inkjet print head 2 disposed on the ink cartridge 1 and interconnecting with the ink storage tank 12. The inkjet print head 2 is used to control output of the ink A. An inkjet print head chip 21 of the present invention is disposed within the inkjet print head 2, and includes a manifold 22, which forms a channel between the inkjet print head 2 and the ink storage tank 12. The inkjet print head 2 further comprises a nozzle layer 23, and a plurality of ink chambers 24 are formed between the nozzle layer 23 and the chip 21.

The chip 21 comprises a plurality of heating elements 211, each of which are used to heat the ink A stored within a corresponding ink chamber 24 to produce bubbles. The nozzle layer 23 comprises a plurality of nozzles 231, each of which corresponds to one of the heating elements 211. When a current passes through the heating elements 211, the ink A within the ink chambers 24 is heated, thereby producing bubbles, and the ink A is then able to be sprayed through the nozzles 231.

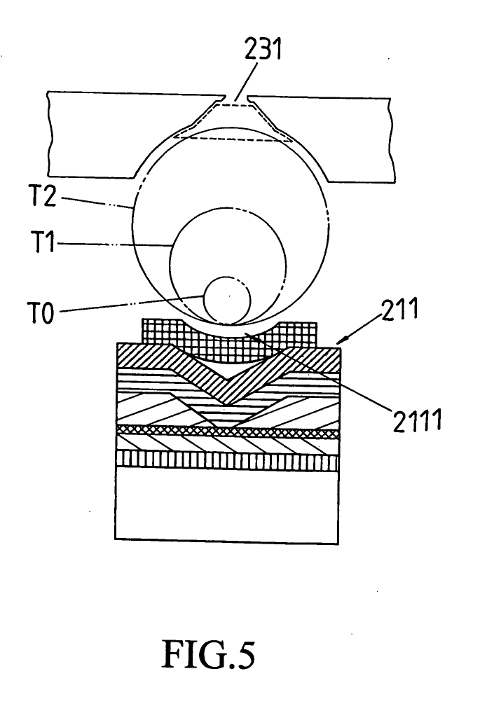

Referring to FIG. 4, which shows a cross-sectional view of the heating element 211 of the present invention, primarily characterized in that structural design of a top edge 2111 of the heating element 211 (that is, a resistance heater element) is of arc-shaped form, and geometric center (that is, heat source center) of the material of the print head chip 21 and a bubble forming center are in a straight line. Referring to FIG. 5, which shows a bubble T0 formed at the heat source center, and because the bubble T0 forms at the point of highest temperature (and not just at the point of highest energy), and geometric center of the material of the chip 21 equals the heat source center, thus, the problem of deviation between the center point of the bubble T0 and the expected emission direction resulting in ink spot quality is eliminated

Principle of steady flow, high voltage inkjet of the present invention:

1. According to the method of metal ion electroplating (PECVD), under equal voltage, thickness of the formation of a metallic film and distance of voltage location are in inverse ratio, thus, a filling phenomenon will naturally occur in a groove, for instance, in the arc line structural form of the top edge 2111 of the heating element 211 of the present invention, as depicted in FIG. 4.

2. According to temperature differences and speed differences produced by the heat source of the aforementioned resistance heater elements 211, experimental results have shown that size requirements of any inkjet spot can be controlled by controlling size of inkjet holes and thickness of a perforated plate.

3. Hence, design of the curved resistance heater element 211 (that is, arc line form resistance heater element), as depicted in FIG. 5, enables controlling the bubble T0 from the ink source under static state conditions, and position, size and temperature of bubbles T1 and T2 formed from a constant ink spot size equally enable stable overlapping at the geometric center of the heat source.

4. According to hydromechanical calculations using a computational vector, quantification equation, inkjet quality is at its highest stability when pressure changes to an arc-shape curve.

In conclusion, the thermal bubble inkjet print head of the present invention uses the heating elements 211 to momentarily direct high heat towards the ink source A and produce bubbles, and because the geometric center of the material of the inkjet print head chip 21 and the bubble forming center are in a straight line, thus, the bubbles only form at the heat source center, thereby eliminating the problem of deviation between the center point of the bubble and the expected emission direction resulting in ink spot quality.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A steady flow, high voltage inkjet print head for an ink cartridge, wherein an inkjet print head chip comprises a plurality of heating elements; a top edge of the heating element is structural designed to be arc-shaped, and geometric center (that is, heat source center) of the material of the inkjet print head chip and a bubble forming center are in a straight line.
